(19) United States
(12) Patent Application Publication
(10) Pub. No.: US 2006/0139392 A1
(43) Pub. Date: Jun. 29, 2006

(54) Detection apparatus

(76) Inventors: Cesar Fernandez, San Diego, CA (US); Antoni Murcia, San Diego, CA (US); David Florez, San Diego, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/026,164

(22) Filed: Dec. 28, 2004

(51) Int. Cl. B41J 29/393

(52) U.S. Cl. 347/19

(57) ABSTRACT

Systems, methods, and devices are provided for detecting an ink drop crossing a plane of light.

Printing systems can employ the use of inkjet printing devices having multiple printheads. The relative positions between the printheads can help with correct ink placement and, therefore, image output. Properly positioned printheads provide accurate ink placement for forming images.

Printheads in some printing systems are replaced when the inks contained therein are depleted. Replacing the printheads may involve removing a printhead from a printhead stall and positioning a replacement printhead therein. Printheads that are not properly positioned (e.g., distanced and/or oriented) relative to one another and/or relative to the print media can create various print quality issues.

Positioning of a printhead in a printhead stall involves various mechanical considerations. The replacement printhead can also be positioned differently with respect to other printheads. Position changes can also be rotational in nature. Alignment techniques involving the use of ink and print media and the analysis of printed alignment patterns can increase operating costs and times in some instances.

### BRIEF DESCRIPTION OF THE DRAWINGS

FIG. 1 illustrates an embodiment of an image forming system.

FIG. 2A illustrates an embodiment of an ink drop detection apparatus.

FIG. 2B illustrates an embodiment of a collimated plane of light relative to an embodiment of a printhead.

FIG. 2C illustrates an embodiment for identifying the position of an ink drop.

FIG. 3A illustrates an embodiment of an ink drop detection apparatus.

FIG. 3B illustrates another embodiment of an ink drop detection apparatus.

FIGS. 4A, 4B, and 4C illustrate embodiments of techniques that can be used to identify one or more dimensional offsets and/or including rotational offsets of a printhead.

### DETAILED DESCRIPTION

Embodiments disclosed herein provide a user with systems, devices, and methods to adjust placement of ink drops for printers that employ a number of printheads. Embodiments can adjust placement of ink drops without printing an adjustment pattern and without controlling the advancement of print media. In various embodiments, the placement of ink drops can be adjusted by the use of an ink drop detection apparatus.

Ink drop detection apparatuses can adjust the timing of the firing of ink drops such that printheads that are out of alignment and/or have nozzles that do not eject ink properly can be at least partially compensated by the adjustment. For example, in some embodiments, a first light source can produce a first plane of light. In such embodiments, the first plane of light can include light that is oriented in an x axis direction and/or a y axis direction. A sensor can be used to detect ink drops passing through the plane of light. And, a processor, such as a digital signal processor can execute computer executable instructions to determine x and/or y dimensions, e.g., x axis and/or y axis dimensional positions of the ink drops passing through the plane of light. By determining the x axis and/or y axis dimensional positions of the ink drops, positional relationships between the ink drops can be determined and at least partially compensated. As stated above, positional relationships can include relationships such as y axis offsets, x axis offsets, and rotational offsets.

For example, where two ink drops are ejected from nozzles on two different printheads, the positional relationships between the printheads can be measured. If the positional relationships are incorrect, such as when one or more printheads are mechanically misaligned the ink drop adjustment device operating on computer executable instructions can at least partially compensate for the misalignment by adjusting the firing of ink drops.

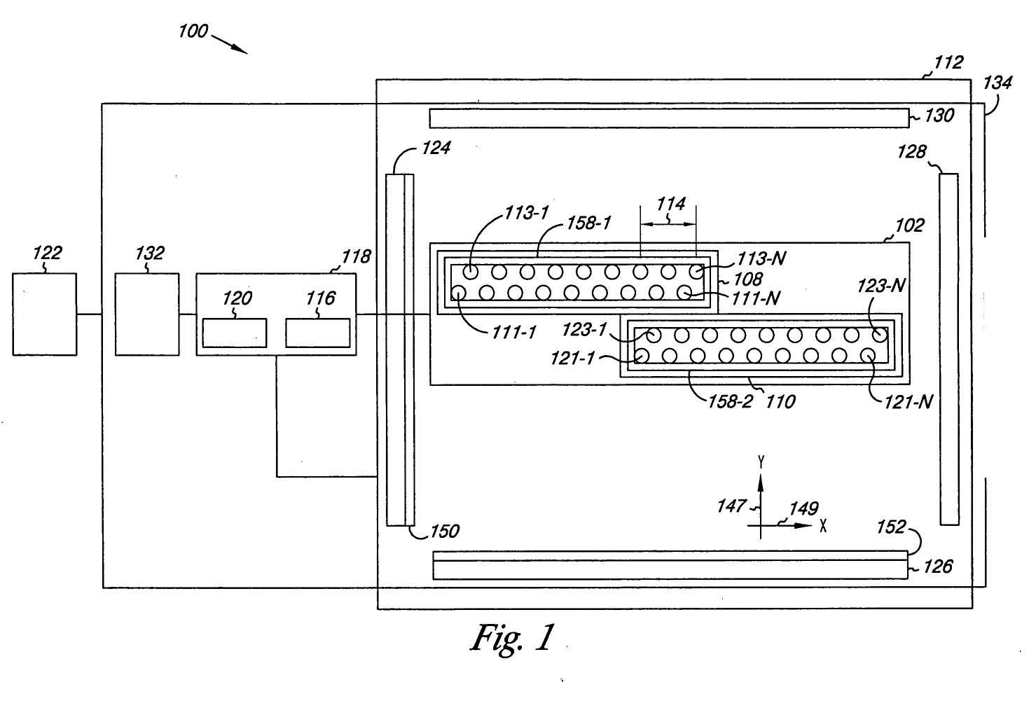

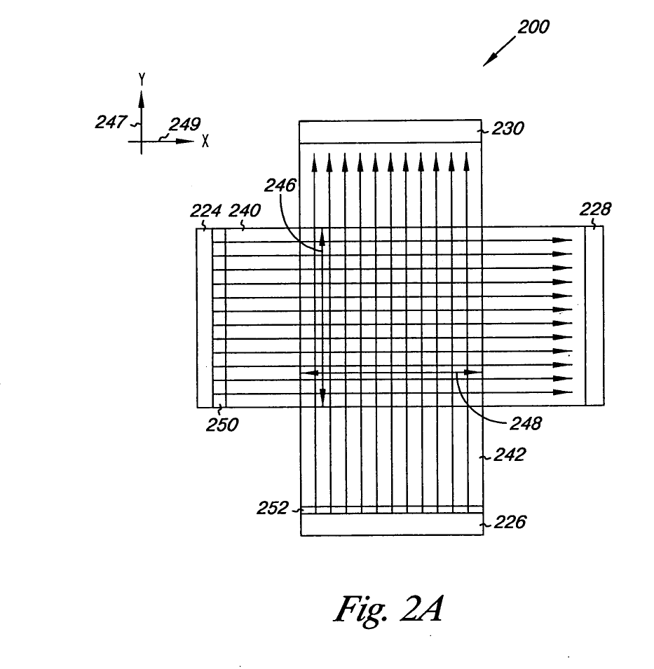

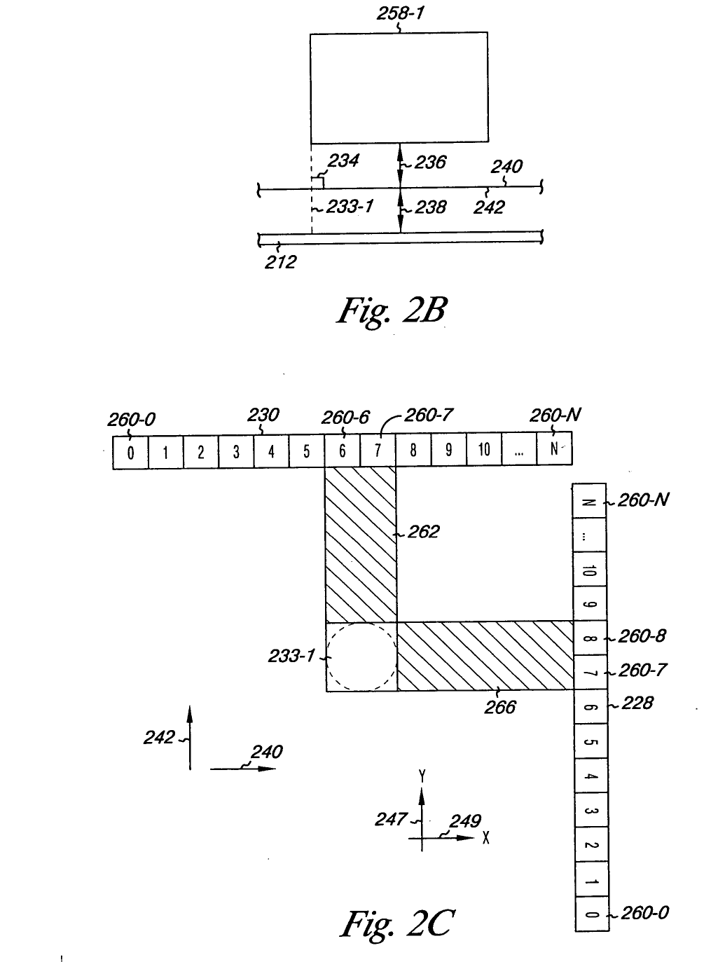

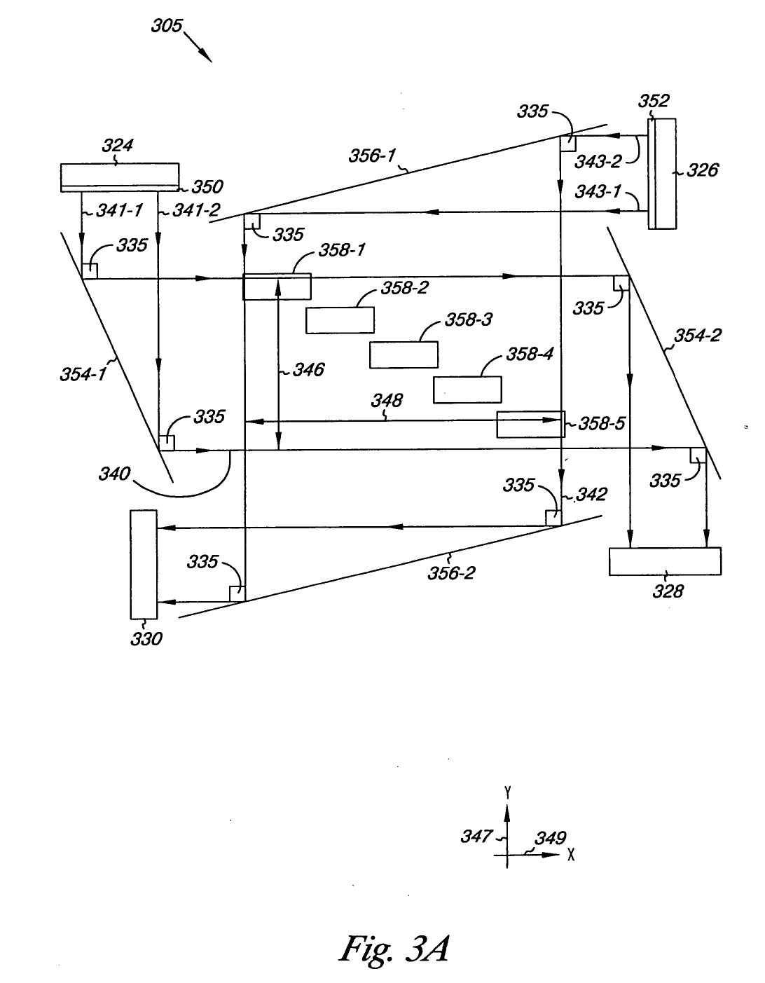

The figures herein follow a numbering convention in which the first digit or digits correspond to the drawing figure number and the remaining digits identify an element or component in the drawing. Similar elements or components between different figures may be identified by the use of similar digits. For example, 110 may reference element “110” in FIG. 1, and a similar element may be referenced as 210 in FIG. 2A. As will be appreciated, elements shown in the various embodiments herein can be added, exchanged, and/or eliminated so as to provide a number of additional embodiments of the ink drop detection apparatus according to the present disclosure.

FIG. 1 illustrates an embodiment of an image forming system 100. Embodiments of an image forming system can include a printing device having at least two printheads for ejecting ink drops and an ink drop detection apparatus for adjusting the ejection of the ink drops. The image forming system embodiment shown in FIG. 1 includes a staggered, stationary inkjet printhead array 102. The printhead array 102 includes two staggered printheads 158-1 and 158-2, which are positioned in two printhead stalls 108 and 110.

The printheads 158-1 and 158-2 each include a number of orifices or nozzles, e.g., nozzles 111-1 through 111-N and 113-1 through 113-N on printhead 158-1 and 121-1 through 121-N and 123-1 through 123-N on printhead 158-2. In the embodiment of FIG. 1, the nozzles on each printhead are arranged in two columns. It is understood, however, that embodiments can include printheads having one or more columns and/or rows of nozzles. Although often referred to as columns, the columns of nozzles shown in the embodiment of FIG. 1 are arranged horizontally, rather than the vertically. In various embodiments, the printheads 158-1 and 158-2 eject ink drops from the nozzles, for example, nozzles 111-1 through 111-N, and onto print media 112 to form a printed image on the print media 112.

In the embodiment shown in FIG. 1, the first stall 108 is a mechanical mounting device for receiving printhead 158-1. The first stall 108 can also be used for positioning the printhead 158-1 within the image forming system 100. However, the embodiments of the present disclosure are not limited to the use of stalls, to the number of stalls, or the number of printheads with each stall. In the embodiment of FIG. 1, the printhead 158-1 includes a first nozzle column and a second nozzle column. The first nozzle column includes nozzles 111-1 through 111-N. The second nozzle column includes nozzles 113-1 through 113-N with both nozzle columns linearly positioned on printhead 158-1.

Also shown in FIG. 1 is a second stall 110. The second stall is a mechanical mounting device for receiving printhead 158-2 and for positioning second printhead within the image forming system 100. The second printhead includes a first nozzle column including nozzles 121-1 through 121-N and a second nozzle column including nozzles 123-1 through 123-N. In various embodiments, nozzles 121-1 through 121-N can be configured in a parallel and staggered position relative to nozzles 123-1 through 123-N.

As shown in FIG. 1, the second stall 110 is positioned offset in the x axis direction and parallel to the first stall 108 thus creating a nozzle overlap zone 114 between the nozzles of printhead 158-1 and the nozzles of printhead 158-2. In various embodiments, printheads are spaced apart and staggered such that the nozzles of each printhead overlap the nozzles of one or more adjacent printheads to permit coverage of ink drop placement on the print media.

In the embodiment shown in FIG. 1, a nozzle overlap zone 114 is illustrated. The nozzle overlap zone 114 includes a number of nozzles on one end of printhead 158-1 and a number of nozzles on one end of printhead 158-2. The overlap allows for continuous coverage across an area of the print media. If the overlapping nozzles are fired together, double coverage of a print media area may result. In such instances, embodiments of the present disclosure can reduce redundant ink drop ejection within the nozzle overlap zone to reduce the double coverage resulting from staggered printheads, by executing computer executable instructions to adjust ink drop placement in the nozzle overlap zone as will be discussed more fully below.

In the embodiment shown in FIG. 1, the image forming system 100 includes an ink drop detection apparatus 134. In some embodiments, the ink drop detection apparatus 134 can include one or more light sources for producing a plane of light. In some embodiments, the light can be collimated into one or more collimated planes of light.

The light sources can include, but are not limited to, light emitting diode (LED), laser, incandescent, and halogen light sources, among others. As shown in FIG. 1, ink drop detection apparatus 134 includes two light sources 124 and 126, each producing a plane of light.

In various embodiments, each light source can include one or more lenses. For example, as shown in FIG. 1, light source 124 includes lens 150 and light source 126 includes lens 152. The lenses 150 and 152 can focus light emitted from light sources 124 and 126 to form a plane of light in an x axis and y axis direction, as will be discussed below with respect to FIGS. 2A and 2B.

In various embodiments, the ink drop detection apparatus can also include a number of sensors. For example, as shown in FIG. 1, ink drop detection apparatus 134 includes sensor 128 and sensor 130. The sensors 128 and 130 can be used to detect ink drops passing through the plane of light produced by light sources 124 and 126 and focused and/or collimated by lenses 150 and 152, as will also be discussed more fully with respect to FIGS. 2A and 2B.

In the embodiment shown in FIG. 1, image forming system 100 includes processor 116. Processor 116 can be any type of suitable processor for executing the various computer executable instructions of the present disclosure. For example, in some embodiments, the processor can include a digital signal processor for executing computer executable instructions for detecting ink drops, determining positional data about the ink drops, and for adjusting ink drop placement on print media.

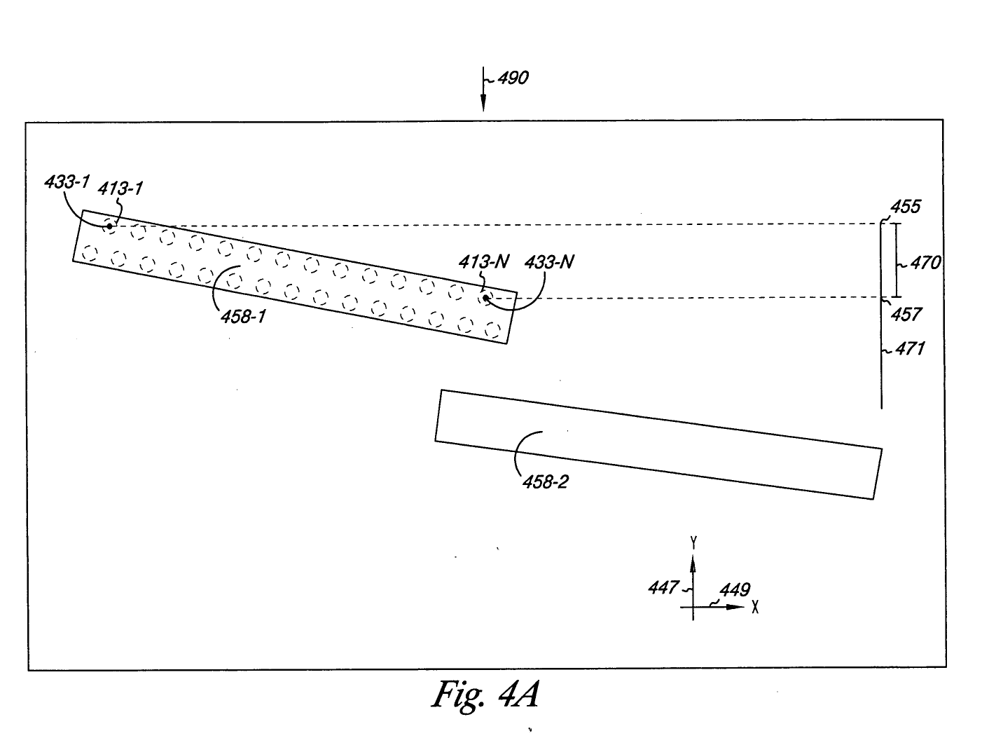

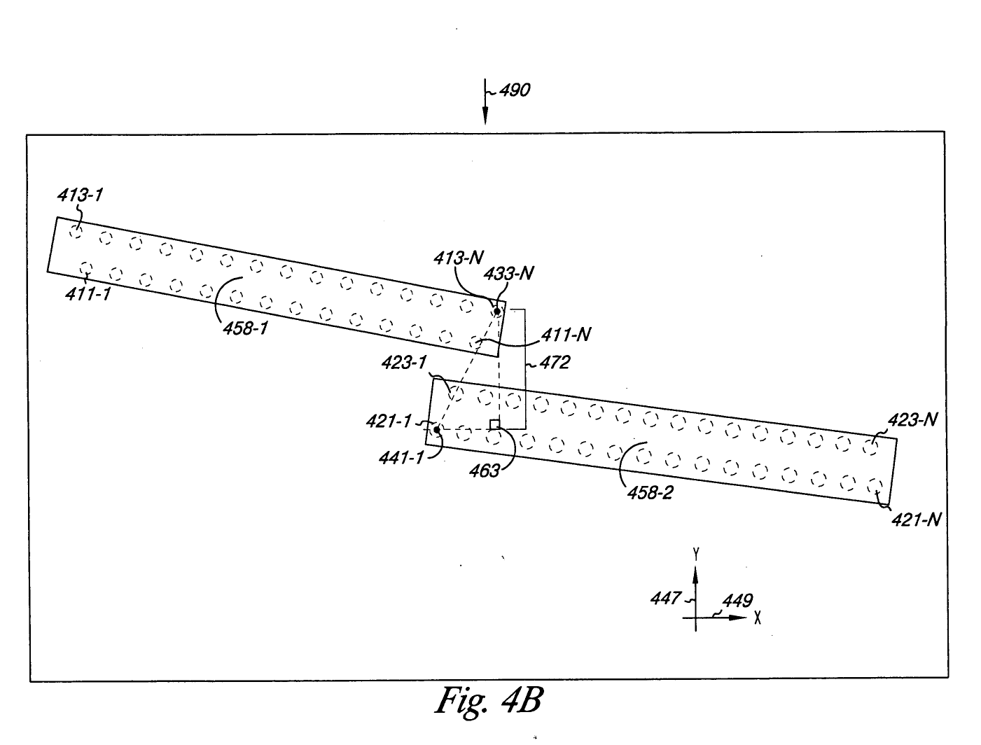

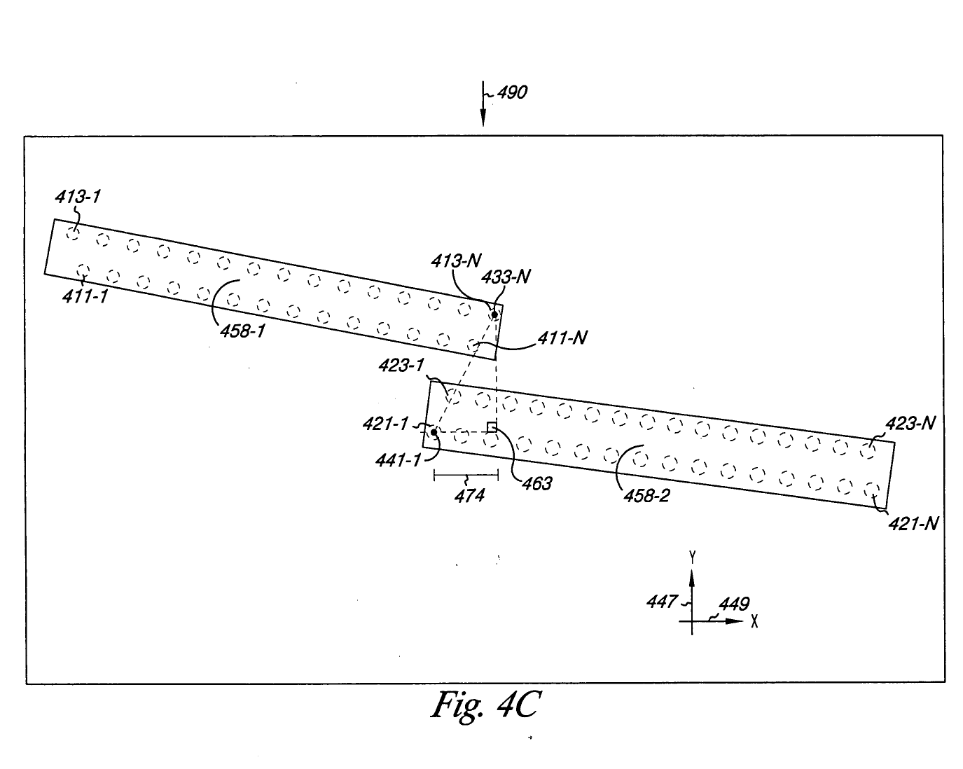

For example, in various embodiments, the processor can operate on computer executable instructions to determine a position of an ink drop within a plane of light based upon detecting the ink drop crossing the plane of light. The processor can operate on computer executable instruction to determine a position of each of a number of ink drops based upon disruption in a plane of light associated with the passing of each ink drop through the plane of light, as will be discussed more fully below, with respect to FIGS. 2C, and 4A-4C.

In various embodiments, the processor can execute computer executable instructions to adjust ink ejection timing of a number of nozzles based upon a number of offsets. In various embodiments, offsets can include x axis offsets, y axis offsets, and rotational offsets.

The y axis offset can include y axis offsets between at least two ink drops ejected from two different printheads. In other embodiments, the processor can execute computer executable instructions to adjust ink ejection timing of a number of nozzles based upon a determined x axis offset. The x axis offset can include x axis offsets between at least two ink drops ejected from two different printheads.

The processor can be used to execute computer executable instructions to identify a rotational offset of a printhead. For example, the rotational offset of the printhead can be determined from a detected position of two or more ink drops ejected from the same printhead or from one ink drop that is compared to a known location stored in memory. In another embodiment, the processor includes a configuration to interpret the data to identify a rotational offset of at least two different printheads.

In various embodiments, the processor includes a configuration to interpret the data to identify a y axis offset between at least two ink drops ejected from two different printheads. In some embodiments, the processor includes a configuration to interpret the data to identify an x axis offset between at least two ink drops ejected from two different printheads.

The processor can include a configuration to interpret the data to identify a rotational offset of a printhead. For example, the rotational offset can be determined from a detected position of two ink drops ejected from the same printhead relative to a reference line.

In embodiments having at least two printheads with a nozzle overlap zone 114, as discussed above, the processor 116 can be operable to adjust ink ejection of a number of the nozzles based upon an x axis offset to reduce redundant ink drop ejection within the nozzle overlap zone 114. Embodiments for identifying and adjusting the various offsets described above will be discussed more thoroughly below with respect to FIGS. 4A-4C.

As shown in FIG. 1, image forming system 100 includes memory 120. Memory can be used, for example, to hold the computer executable instructions and other information useful for detecting ink drops, determining positional data about the ink drops, and for adjusting ink drop placement on print media. In various embodiments, the memory 120 can include software to control the operation of the light sources 124 and 126 and the optical sensors 128 and 130.

Memory 120 can include various volatile and non-volatile memory types. For example, in various embodiments, memory 120 can include some combination of volatile and non-volatile memory, such as ROM, RAM, and flash memory, for example. Memory can be provided that is magnetic or optically readable media, among others.

In some embodiments, the processor 116 and memory 120 can be associated with a controller 118. The controller 118 including the processor 116 and memory 120 can be coupled to various components of the image forming system 100 for receiving, processing, and sending data to various components of the image forming system 100. For example, the controller 118 can be coupled to a user interface 132. The user interface 132 can initiate a printhead adjustment program by sending computer executable printing instructions to the printhead array 102. Light sources 124 and 126 and optical sensors 128 and 130 can be used to detect ink drops ejected from printhead array 102. The controller 118 can receive information about the detected ink drops and process the information using processor 116. In some embodiments, the controller can send the information about the detected ink drops to a remote device 122. For example, the remote device 122 can include a processor remotely connected to the image forming system 100 for processing, as will be discussed more fully with respect to FIGS. 4A-4C. The user interface 132 can provide controls for a user to initiate printhead adjustment or to program the printer to perform automatic printhead adjustment, for example. The user interface can include, but is not limited to, a display, a keyboard, a touch screen, a mouse, and/or other types of interface mechanisms.

In various embodiments, the remote device 122 can include a network, a stand alone computer, among other things. The remote device 122 can be coupled to the image forming system 100 via a wired or wireless connection.

FIG. 2A illustrates an embodiment of an ink drop detection apparatus. In FIG. 2A, a number of light sources and sensors are illustrated. The light sources shown in FIG. 2A include a first light source 224 and a second light source 226. The first light source 224 produces a first plane of light 240. In various embodiments, the first plane of light can be directed in an x axis direction 249. The second light source 226 produces a second plane of light 242. In various embodiments, the second plane of light can be directed in a y axis direction 247.

In the embodiment shown in FIG. 2A, the first light source 224 directs a first plane of light 240 across an area in which ink drops will pass. The directed light 240 is sensed by a sensor 228 positioned in the path of the directed light 240. Likewise, second light source 226 directs a plane of light 242 across an area in which the ink drops will pass. The directed light 242 is sensed by a sensor 230. In various embodiments of the present disclosure the planes of light 240 and 242 can be oriented within the same physical plane. In other embodiments, the planes of light 240 and 242 can be oriented in different physical planes, i.e., the plane of light 240 positioned above or below the plane of light 242.

In the embodiment shown in FIG. 2A, the directed planes of light 240 and 242, i.e., first and second planes of light, overlap at a perpendicular angle. The area in which the two planes overlap can be described in terms of a length 246 and a width 248. In FIG. 2A, an x axis 249 and a y axis 247 are defined in order to aid the reader in understanding the embodiments of the present disclosure.

In various embodiments, the length and width 246 and 248 can include dimensions that equal or exceed the length and width of one or more printheads, as will be discussed below.

In some embodiments, a computer generated coordinate plane can be used to aid in determining the position and orientation of an ink drop. For example, a Cartesian coordinate plane having an x and y axis can be determined based upon spatial reference points defined by Charged Coupled Device (“CCD”) elements of an optical sensor, as will be discussed below in FIG. 2B. The computer generated Cartesian coordinate plane can be used to determine an x coordinate and a y coordinate of an ink drop passing through the planes of light, as will be discussed more thoroughly below with respect to FIGS. 4A-4C.

In some embodiments, the light sources can produce collimated planes of light. In some embodiments, the planes of light can be collimated by lenses, as discussed in more detail below. As used herein, a collimated plane of light is a plane of light having light rays that are parallel or substantially parallel.

In various embodiments, the ink drop detection apparatus can include a number of lenses. A lens can be used to form a collimated plane of light in at least one of the x axis and y axis directions. Thus, the lens can focus light, such as convergent and/or divergent light, to produce a collimated light plane having substantially parallel light rays. For example, as shown in FIG. 2A, the first and second light sources 224 and 226 each include lenses 250 and 252 that focus light emitted from each of the first and second light sources 224 and 226 into a plane of collimated light in both the x axis and y axis directions 249 and 247.

FIG. 2B illustrates an embodiment of a collimated plane of light relative to an embodiment of a printhead. In various embodiments, the first and second light sources can produce first and second light planes. In some the embodiments, the first and second planes of light can include collimated planes of light directed in the x axis and the y axis directions. The first and second planes of light can also, in some embodiments, be oriented perpendicular or substantially perpendicular to a trajectory of the ink drop. In embodiments using collimated planes of light, for example, the collimated planes of light are produced such that their planes are positioned substantially perpendicular to the trajectory in which ink drops travel after being ejected from nozzles of one or more printheads.

For example, as shown in FIG. 2B, printhead 258-1 ejects ink drop 233-1. As ink drop 233-1 passes through the planes of light 240 and 242 (illustrated in the embodiment shown in FIG. 2B as being in the same physical plane) and before ink drop 233-1 impacts print media 212, it is detected by sensors receiving the collimated planes of light 240 and 242, as will be discussed in FIG. 2C. As shown in FIG. 2B, the intersection 234 between the trajectory of the ink drops 233-1 and the collimated planes of light 240 and 242 in both the x axis and y axis directions forms a right angle in a z coordinate dimension.

In various embodiments, the collimated planes of light in the x axis and y axis directions can be positioned between a printhead and print media. In such embodiments, the distance between the collimated light planes and printhead nozzles is the printhead to plane distance. For example, as shown in FIG. 2B, the printhead to plane distance 236 includes the distance between a nozzle on printhead 258-1 and at least one of the collimated planes of light 240 and 242. In various embodiments, knowing the printhead to plane distance 236 and the plane to media distance 238 can help to adjust print quality by adjusting the ejection of ink drops, as will be discussed in more detail below.

FIG. 2B, illustrates an embodiment in which the printhead to plane distance 236 is equal to the distance between the collimated light planes and print media, i.e., the plane to media distance 238 in which ink drops are deposited. However, in some embodiments, the printhead to plane distance 236 and the plane to media distance 238 can be unequal distances.

FIG. 2C illustrates an embodiment for identifying the position of an ink drop. The sensing apparatus embodiment shown in FIG. 2C includes a sensor 228 and a sensor 230. In various embodiments, the sensors can include high-resolution optical sensors having a number of CCDs.

For example, in the embodiment shown in FIG. 2C, CCD elements are shown as elements 260-0 through 260-N on sensor 228 and sensor 230. In various embodiments, the CCD elements that can be spaced at a fixed pitch and arranged in a linear manner. For example, CCD elements 260-0 to 260-N on both sensors 228 and 230 can be spaced at a fixed pitch of 2,400 CCD elements per linear inch. However, in the embodiment shown in FIG. 2C, the illustration is enlarged to show the detail of the CCD elements with respect to shadows 262 and 266 cast by an ink drop 233-1 passing through two overlapping planes of light. It is understood however, that any number of CCD elements can be used.

In various embodiments, the sensor can be used to detect an ink drop passing through at least one of the planes of light. For example, in the embodiment shown in FIG. 2C, ink drop 233-1 is illustrated from a top down perspective passing through two planes of light oriented in the x axis 249 and the y axis 247 directions. As illustrated in FIG. 2C, ink drop 233-1 produces ink drop shadows 262 and 266.

The ink drop shadows are cast by rays of light produced by light sources, for example, light sources 224 and 226 illustrated in FIG. 2A. As the ink drop 233-1 passes through the planes of light in the x axis and y axis directions, the ink drop shadows 262 and 266 are cast on sensors 228 and 230. The shadows are detected by sensors 228 and 230. For example, as shown in FIG. 2C, sensor 228 detects ink drop shadow 266, which is cast on sensor 228 as the ink drop passes through the plane of light in the x axis direction 249. Similarly, sensor 230 detects ink drop shadow 262, which is cast on sensor 230 as the ink drop passes through the plane of light in the y axis direction 247.

The ink drop shadows are cast on the sensors when light rays contact the ink drop. At contact, the light rays scatter in various directions. Most of the scattered light rays are not detected by the first and second sensors and, therefore, a shadow is produced on a portion of the first and second sensors. The detection of the shadows provides the ability for the first and second sensors, in conjunction with a processor operating on computer executable instructions, to determine an x axis dimensional position and a y axis dimensional position of the detected ink drop passing through the planes of light, as will be discussed more thoroughly with respect to FIGS. 4A-4C below.

Because the positions of the CCD elements can be measured, the position of the ink drop can be identified. For example, the x axis 249 and y axis 247 include a measurable distance on both axes that are defined by the width of the CCD elements 260-0 through 260-N on sensors 228 and 230 and any spacing provided between them.

Computer executable instructions can operate on the spatial reference points in relation to the detected ink drops to determine the x axis and y axis positions of the ink drops. For example, the x and y axis positions can be determined based upon a computer generated Cartesian coordinate plane.

As discussed above, in FIG. 2C, for example, a plane of light in the x axis direction is represented by plane 240 and a plane of light in the y axis direction is represented by plane 242. In FIG. 2C, a shadow in the x axis direction 266 is produced when light in the x axis direction 240 strikes ink drop 233-1. Similarly, a shadow in the y axis direction 262 is produced when light in the y axis direction 242 strikes ink drop 233-1. As shown in FIG. 2C, first sensor 228 detects shadow 266 at CCD elements 260-7 and 260-8 and second sensor detects shadow 262 at CCD elements 260-6 and 260-7.

By using CCD elements 260-0 on both sensors 228 and 230 as spatial reference points and knowing the number of CCD elements on each sensor, a two-dimensional Cartesian plane, having an x axis and y axis, can be computer generated, and thus, x and y dimensions can be determined using computer executable instructions that are executed by a processor. Knowing the x and y dimensions on the Cartesian plane can provide the ability to assign such dimensions to an ink drop, and ultimately, adjust the placement of ink drops, as will be discussed with respect to FIGS. 4A-4C.

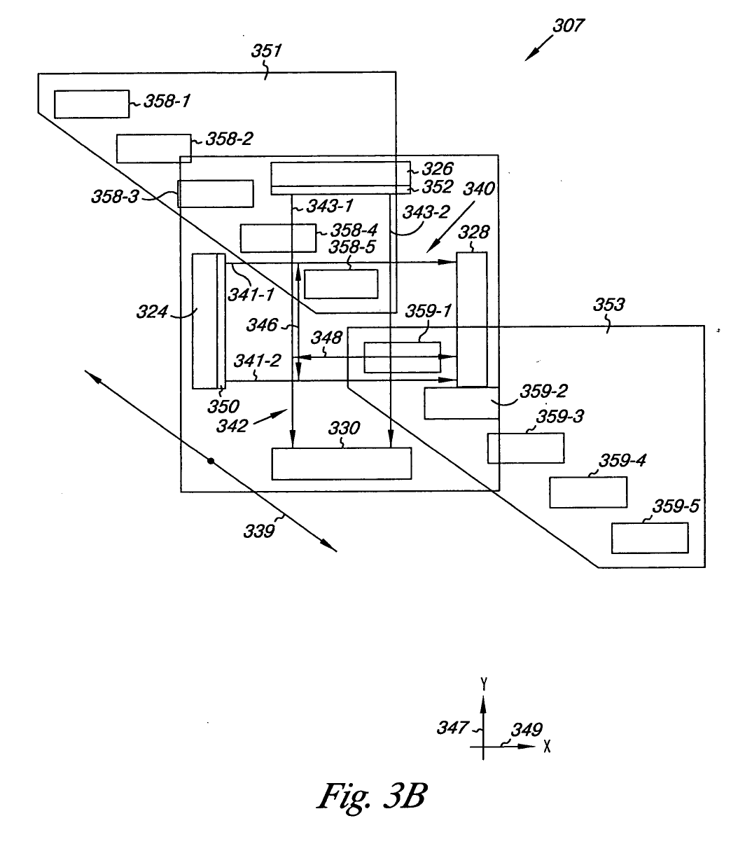

FIGS. 3A and 3B illustrate various embodiments of an ink drop detection apparatus. Some embodiments of the ink drop detection apparatus are mobile, while other embodiments are stationary. The differences between a mobile and stationary ink drop detection apparatus include an ability to detect ink drops over a wider area. For example, in embodiments where the ink drop detection apparatus is stationary, the length and width of the area in which the two light planes overlap, as described above with respect to FIG. 2A, can be larger relative to embodiments where the ink drop detection apparatus is mobile. Embodiments of a stationary ink drop detection apparatus will be discussed below with respect to FIG. 3A and embodiments of a mobile ink drop detection apparatus will be discussed below with respect to FIG. 3B.

FIG. 3A illustrates an embodiment of an ink drop detection apparatus. The ink drop adjustment apparatus illustrated in FIG. 3A includes an embodiment of a stationary ink drop detection apparatus. In FIG. 3A, a set of printheads are illustrated. The set of printheads includes a staggered, stationary inkjet printhead array having printheads 358-1, 358-2, 358-3, 358-4, and 358-5. Also shown in FIG. 3A are light sources 324 and 326. As discussed above with respect to FIGS. 1 and 2A, light sources 324 and 326 each produce a plane of light. As shown in FIG. 3A, the first light source 324 produces a plane of light 340 which is directed in an x axis direction 349. And, the second light source 326 produces a plane of light 342 that is directed in a y axis direction 347. In some embodiments, such as the embodiment shown in FIG. 3A, the planes of light are reflected off mirrors 356-1 and 356-2. Some of the functions and uses of the mirrors will be discussed in more detail below.

Also used in the embodiment shown in FIG. 3A, are lenses 350 and 352. As discussed above with respect to FIG. 2A, lenses 350 and 352 focus the light emitted from light sources 324 and 326 into planes of light respectively, as will be discussed in more detail below.

FIG. 3A, includes a number of reflective members, e.g., a mirrors. The use of mirrors can allow an ink drop detection apparatus to provide a large detection area and, thus, the ability to detect ink drops from a number of printheads, e.g., printhead array having printheads 358-1, 358-2, 358-3, 358-4, and 358-5, as discussed above.

For example, the mirrors can be used to widen a plane of light, for example, by positioning the mirrors at an angle relative to a light source producing the plane of light. By angling the mirrors relative to their respective light sources, the mirrors can modify a plane of light by widening and/or narrowing the planes of light in an x axis and/or a y axis direction.

Mirrors widen a plane of light by reflecting the plane of light to cover an area having a length and width sufficient for the detection of ink drops ejected from a particular number of printheads. In addition, mirrors can narrow the reflected plane of light for detection by optical sensors. In the embodiments described herein, the mirrors are angled such that planes of light in an x axis and y axis direction are angled to each other, e.g., at right angles.

As shown in FIG. 3A, ink drop detection apparatus 305 includes two sets of mirrors. The first set of mirrors 354-1 and 354-2 include reflective surfaces that oppose each other. The mirrors 354-1 and 354-2 are positioned such that light reflected off the mirrors 354-1 and 354-2 is reflected at a 90 degree angle 335.

Also shown in FIG. 3A is a second set of mirrors 356-1 and 356-2. The second set of mirrors 356-1 and 356-2 also include reflective surfaces that also oppose each other and are positioned such that light reflected off the mirrors 356-1 and 356-2 is reflected at a 90 degree angle 335.

For purposes of ease of illustration, in the embodiment shown in FIG. 3A, two light rays in an x axis direction 341-1 and 341-2 and two light rays in a y axis direction 343-1 and 343-2 are illustrated. These light rays are intended to illustrate the direction of travel of the planes of light in both the x axis and y axis directions. Although two light rays in the x axis and y axis directions are illustrated, the planes of light in both the x axis and y axis directions can include many light rays.

In addition, light rays 341-1 and 341-2 are intended to illustrate the outermost light rays in a plane of light 340 in the x axis direction 349 having many light rays. Similarly, light rays 343-1 and 343-2 are intended to illustrate the outermost light rays in the y axis 347 direction having many light rays.

As discussed above with respect to FIG. 2A, lenses 350 and 352 can focus planes of light emitted from light sources 324 and 326 into planes of light. In some embodiments, the lenses can be used to create collimated planes of light, e.g., parallel light rays.

As shown in FIG. 3A, light source 324 emits light, which is focused by lens 350 to form two parallel light rays 341-1 and 341-2. As discussed above, mirrors can be used to reflect light at various angles. For example, in the embodiment shown in FIG. 3A, mirror 354-1 is angled to reflect the light rays 341-1 and 341-2 at a right angle, e.g., a 90 degree angle 335. This also acts to widen the plane of light. The reflected and widened light rays 341-1 and 341-2 in the x axis direction 349 cover a space occupied by printheads 358-1 through 358-5.

As shown in FIG. 3A, the light rays 341-1 and 341-2 are reflected in the x axis direction 349. In the x axis direction 349, the light rays include a height 346 on the y axis 347. The light rays 341-1 and 341-2, having height 346, reflect from mirror 354-1 and approach opposing mirror 354-2. Mirror 354-2 reflects light rays 341-1 and 341-2 at a right angle, e.g., a 90 degree angle 335, and as a result, the plane of light including light rays 341-1 and 341-2 is narrowed for detection by sensor 328.

Similarly, light source 326 emits light, which is focused by lens 352 to form two parallel light rays 343-1 and 343-2. A second set of mirrors can be used to reflect the light from light source 326 at various angles. For example, in the embodiment shown in FIG. 3A, mirror 356-1 is angled to reflect the light rays 343-1 and 343-2 at a right angle, e.g., a 90 degree angle 335. The angling of the light can also act to widen the plane of light as discussed above with respect to the light from the light source 324. The reflected and widened light rays 343-1 and 343-2 in the y axis direction 347 also cover a space occupied by printheads 358-1 through 358-5.

The length and width of the planes of light can be adjusted by mirrors to cover an area for detecting ink drops by sensors 328 and 330. Thus, in various embodiments, the mirrors can be used to modify light such that the height and width of the planes of light cover an area occupied by some or all of the printheads of a printing device.

In various embodiments, the ink drop detection apparatus can be housed within a service station of a printing device. As used herein, a service station includes an area on a printing device in which printing components can be serviced, as for example, printheads on a printing device. In such an embodiment, printheads can be moved away from a print zone within a service station in which an ink drop detection apparatus is positioned. As used herein, a print zone includes a location on a printing device in which printheads eject ink drops onto print media.

FIG. 3B illustrates another embodiment of an ink drop detection apparatus. The mobile ink drop detection apparatus illustrated in FIG. 3B includes two light sources 324 and 326, two lenses 350 and 352, and two sensors 328 and 330 respectively.

As shown in FIG. 3B, the planes of light in both the x axis and y axis directions include a length 348 and a width 346. The length and width of the planes of light can help to determine x and y dimensions of ink drops passing through the planes of light in the x axis and y axis directions, as will be discussed below in FIGS. 4A-4C.

Similar to FIG. 3A above, and for purposes of ease of illustration, in the embodiment shown in FIG. 3B, two light rays in an x axis direction 341-1 and 341-2 and two light rays in a y axis direction 343-1 and 343-2 are illustrated. These light rays are intended to illustrate the direction of travel of planes of light in both the x axis and y axis directions.

As shown in FIG. 3B, light rays 341-1 and 341-2 can be collimated by lens 350. That is, lens 350 can focus the light emitted from light source 324 into light rays that are parallel to each other. The plane of light 340 in the x axis direction can cover a space occupied by printhead 358-5 of a first printhead set 351 and printhead 359-1 of a second printhead set 353. The space includes a height 346 on the y axis 347 that constitutes the overlap of the planes of light 340 and 342 in the x axis and y axis directions. Sensor 328 can detect ink drops ejected from printheads 358-5 and 359-1 on an x axis 349 of a two dimensional Cartesian coordinate plane as discussed above. By detecting ink drops from printheads 358-5 and 359-1, x and y dimensions can be assigned to the detected ink drops ejected from those printheads.

Similarly, light rays 343-1 and 343-2 can be collimated by lens 352. The plane of light 342 in the y axis direction covers a space occupied by a portion of printhead 358-4, printhead 358-5, and a portion of printhead 359-1. The space includes a width 348 on the x axis 347 that constitutes the overlap of the planes of light 340 and 342 in both the x axis and y axis directions. Sensor 330 can detect a number of ink drops ejected from printhead 358-4, all of the ink drops ejected from printhead 358-5, and a number of ink drops ejected from printhead 359-1 on an x axis 349 of a two dimensional Cartesian coordinate plane as discussed above. By detecting ink drops from the printheads 358-4, 358-5, and 359-1, positions of each of the ink drops, in the x and y dimensions, can be identified.

Knowing the x and y dimensions of ink drops ejected from one or more printheads can provide the ability to determine a positional relationship between two or more printheads and a positional relationship of a single printhead relative a reference line or other reference point, as will be discussed with respect to FIGS. 4A-4C.

The embodiment shown in FIG. 3B includes a mobile ink drop detection apparatus. As used herein, a mobile ink drop detection apparatus includes an apparatus that can travel along a predetermined path and detect ink drops from one or more printheads. In such embodiments, the mobile ink drop detection apparatus can detect ink drops ejected from a printhead within a print zone. For example, in the embodiment shown in FIG. 3B, the ink drop detection apparatus 307 can travel along predetermined path 339 in a print zone while detecting ink drops from one or more printheads.

The ink drop detection apparatus can be moved in various ways. For example, the ink drop detection apparatus can be placed on a track positioned above print media and below the printheads.

FIGS. 4A, 4B, and 4C illustrate embodiments of techniques that can be used to identify x, y, and/or rotational offsets of a number of printheads. Techniques can include, but are not limited to, measuring positional data relative a reference line, measuring positional relationships between a number of printheads, and comparing positional data to alignment data, among others.

Positional data includes data that represents x and y dimensions, for example, on a Cartesian plane of a detected ink drop ejected from a printhead. As used herein, positional relationships can include an x and/or a y coordinate of a detected ink drop ejected from a printhead. This position can be relative to an x and/or a y coordinate of a different ink drop ejected from the same printhead and/or a different printhead. Alignment data includes x and y coordinate data that is stored in memory and which represents ink drops that are ejected from properly positioned and aligned printheads.

A properly positioned printhead is a printhead that is properly positioned relative to a media advance direction in a printing system, such as image forming system 100 illustrated in FIG. 1. Properly aligned printheads are printheads that are properly aligned in the printing system relative to each other, e.g., printheads are properly positioned and properly distanced from each other.

A misalignment of a printhead and/or printheads includes situations where the nozzles of a printhead are not mechanically positioned properly with respect to a media advance direction and/or the nozzles of an adjacent printhead. Misalignment can exist between printheads when the nozzles of a first printhead are spatially positioned relative to the nozzles of a second printhead such that ink drops ejected from the nozzles of the first printhead do not fall onto the media in the desired location relative to the ink drops ejected from other nozzles on the first printhead, or relative to the ink drops ejected from the nozzles of the second printhead.

Misalignment in the y axis direction and rotational offset misalignment can be reduced by adjusting the timing of nozzle ink ejection. Misalignment in the x axis direction can be reduced by disabling nozzles that cause redundant ink drop ejection within nozzle overlap zone 114, as shown in FIG. 1.

In various embodiments the positional data, e.g., x and/or y dimensions for each detected ink drop can be compared to alignment data stored in a memory, e.g., x and/or y dimensions. Thus, in various embodiments, a processor can access memory to adjust ink ejection timing based on comparing alignment data stored in memory to positional data taken from measuring actual ink firing. If a difference between alignment data and positional data exists, a processor can execute computer executable instructions for adjusting the ink ejection such that the positional data substantially equals or equals the alignment data.

In the embodiments illustrated in FIGS. 4A, 4B, and 4C, computer executable instructions can be embodied in software, firmware, and/or circuit logic, among others. Additionally, the computer executable instructions may be used by a processor to control nozzle ink ejection to adjust ink placement on print media.

The positional data can be used by a controller (e.g., a controller including memory and a processor) to calculate various offsets. The offsets can be used to adjust the ink ejection of printhead nozzles to adjust ink placement from the printhead arrays and/or individual printheads and/or to adjust the number of nozzles that eject ink. For example, the positional data may be used by a processor executing computer executable instructions within software to adjust an offset in the x or y dimensions, or to adjust a rotational offset, i.e., angular offset in the x and y dimensions, relative to a reference line, for example.

In the embodiments shown in FIGS. 4A, 4B, and 4C, two printheads 458-1 and 458-2 are illustrated from a top down perspective. The two printheads 458-1 and 458-2 are intended to be horizontal, e.g., perpendicular to the direction of media travel. However, as illustrated in FIGS. 4A, 4B, and 4C, the printheads 458-1 and 458-2 are not perpendicular, but askew which represents misalignment of the printheads 458-1 and 458-2. In each of the embodiments illustrated in FIGS. 4A, 4B, and 4C, the printheads 458-1 and 458-2 are positioned above planes of light provided in the x axis and/or y axis directions.

FIG. 4A illustrates one example of how positional data can be measured. In FIG. 4A, the two printheads 458-1 and 458-2 are positioned offset relative to each other in both the x and y dimensions, as such dimensions are identified by reference lines 447 and 449 of FIG. 4A.

In this example, the positioning of one printhead can be identified based upon the relation of at least two ink drops fired from the printhead. In the example shown in FIG. 4A, the positions of two ink drops 433-1 and 433-N, fired from nozzles 413-1 and 413-N respectively are measured based upon their relation to a reference line 471. However, the embodiments of the present disclosure are not so limited.

In the embodiment of FIG. 4A the ink drops are detected when they pass through a plane of light in the x axis and/or y axis directions (e.g., such as the planes of light in the x axis and y axis directions shown in FIGS. 3A-3B). The detected ink drops can be converted into ink drop positional data representing x and/or y dimensions, such as on a Cartesian coordinate plane, as discussed above.

The embodiment shown in FIG. 4A represents an exaggerated printhead misalignment, e.g., much more out of alignment than typically experienced for purposes of ease of illustration. The embodiment in FIG. 4A also illustrates two printheads 458-1 and 458-2 that are rotationally offset relative to the reference line 471.

In the embodiment shown in FIG. 4A, the reference line 471 represents a line in the y axis direction 447 having y coordinate positions that are stored in memory. The reference line or other data stored in memory can include a direction of print media advancement in the printing system. In such embodiments, the position of detected ink drops ejected from nozzles can be used by software to calculate a rotational offset distance 470 relative to the reference line 471.

In FIG. 4A, two ink drops 433-1 and 433-N are shown. Ink drop 433-N is shown ejected from the right most nozzle 413-N of second nozzle column 413-1 through 413-N of printhead 458-1. Ink drop 433-1 is shown ejected from the left most nozzle 413-1 of second nozzle column 413-1 through 413-N.

An ink drop detection apparatus, such as ink drop detection apparatuses shown in FIGS. 3A and 3B, can be used to detect ink drops 433-1 and 433-N as they pass through the planes of light in the x axis and/or y axis directions 449 and 447. A processor, such as processor 116 shown in FIG. 1, and/or a remote device 122, e.g., remote processor can determine an x and/or y coordinate, e.g., x axis and y axis dimensional position of ink drops 433-1 and 433-N. That is, the processor can execute computer executable instructions to determine the positional data regarding the detected ink drops to determine an x and/or y coordinates of the ink drops detected by the ink drop detection apparatus.

As discussed above, the positional data representing the x and y dimensions of ink drops 433-1 and 433-N can be sent to memory, such as memory 120 shown in FIG. 1. Software embodiments can calculate intersecting points 455 and 457 which are positioned horizontally to the detected ink drops 433-1 and 433-N and which intersect reference line 471.

The rotational offset of printhead 458-1 can be calculated by measuring the distance between the intersecting points 455 and 457. The distance measured 470 represents the rotational offset of printhead 458-1 from the reference line 471, e.g., rotational offset of printhead 458-1 relative to the media advance direction 490.

The offset distance data can be calculated and instructions can be sent, for example by software, for adjusting nozzle ink ejection timing according to the offset distance 470, to the processor, such as the processor 116 shown in FIG. 1 and/or remote device 122, e.g., remote processor.

For example, the processor 116 shown in FIG. 1 can provide a controller with alignment data to adjust the timing of ink ejection of printhead 458-1 when printed lines printed by printhead 458-1 are determined by the processor not to be horizontal or perpendicular to the reference line 471, thus indicating a rotational offset, i.e., angular offset. The controller can adjust the timing of the ejection of ink drops according to the rotational offset on the vertical-axis 447 such that printed lines on the horizontal-axis 449 can be printed substantially horizontal, i.e., substantially perpendicular relative to the vertical reference line 471 and/or media advance direction 490, after the adjustment is performed.

FIGS. 4B and 4C are represented by two printheads 458-1 and 458-2, positioned offset relative to an x axis 447 and a y axis 449. The offset printheads provide examples of an ink drop ejected from nozzles of two misaligned printheads where the printheads may be mechanically misaligned. Such embodiments can also be used where printhead ink drop ejection timing may be incorrect and/or where an incorrect number of nozzles in an overlapping area between printheads may be ejecting ink. However, the embodiments are not limited to adjustment of printheads where one nozzle of each printhead is ejecting ink.

FIGS. 4B and 4C illustrate an embodiment of the manner in which ink drop positional data can be used to adjust a linear offset distance of ink placement on a y axis between printheads and a linear offset distance of ink placement between printheads on an x axis, respectively. In such embodiments, the positional data of one printhead can be compared to the positional data of another printhead. The positional data from each printhead can be compared and positional relationships can be determined.

The positional relationships between the two printheads can include the orientation and distance between the two printheads, e.g., relative orientations and distance between the two printheads. The orientation and distances can be compared to data stored in memory that represents proper orientation and distance.

In the embodiment shown in FIG. 4B, a linear offset distance 472 can be calculated between printheads in a y axis direction 447 and an x axis direction 449. The embodiment in FIG. 4B shows two printheads 458-1 and 458-2 with a linear offset between the two printheads 458-1 and 458-2 in both a y axis direction 447 and an x axis direction 449. However, for purposes of illustration and not for limiting the embodiments, in the embodiment of FIG. 4B, adjustment of the two printheads is illustrated with respect to the y axis direction 447.

By way of example, and not by way of limitation, the positional data representing the x and y coordinates, e.g., x axis and y axis dimensional positions of ink drops, can be analyzed by a software program that operates on the data by determining positional data relating to nozzles of the first printhead 458-1 and nozzles of the second printhead 458-2, as for example, the x and y dimensions representing ink drops 433-N and 441-1. As shown in FIG. 4B, ink drop 433-N is ejected from the right most nozzle 413-N of second nozzle column 413-1 through 413-N of printhead 458-1. Ink drop 441-1 is shown ejected from the left most nozzle 421-1 of first nozzle column 421-1 through 421-N. The ink drops 433-N and 441-1 can be detected as they pass through the one or more planes of light provided in the x axis and/or y axis direction.

Computer executable instructions can be used to calculate an intersection point 463, which is positioned vertically from the x and y dimensions of ink drop 433-N on printhead 458-1, and positioned horizontally from the x and y dimensions of ink drop 441-1. The linear offset distance 472 can be measured by calculating the distance between the y coordinate of ink drop 433-N and the y coordinate of the intersection point 463. The distance measured represents the linear offset 472 between the printhead 458-1 and printhead 458-2 in the y axis direction 447.

Computer executable instructions can also be used to calculate the adjustment of nozzle ink ejection firing and/or nozzle ejection timing according to the offset distance calculated above. For example, a processor can be used to adjust nozzle ink ejection firing/timing of one or more printheads or one or more nozzles thereon based upon the offset data calculated by the processor.

In the embodiment shown in FIG. 4C, an offset distance 474 can be calculated between printheads in the x axis direction 351. Offset distance 474 can correspond to nozzle overlap zone 114 shown in FIG. 1. The embodiment in FIG. 4C is identical to the embodiment shown in FIG. 4B, except in FIG. 4C adjustment of the two printheads is illustrated with respect to the x axis direction 449.

In this embodiment, the software can calculate an intersection point 463, which is positioned vertically from an x and y coordinate of ink drop 433-N on printhead 458-1, and positioned horizontally from an x and y coordinate of ink drop 441-1. The linear offset distance 474 can be measured by calculating the distance between the x coordinate of ink drop 421-N and the x coordinate of the intersection point 463. The distance measured represents the linear offset distance 474 between the nozzles of printhead 458-1 and the nozzles of printhead 458-2 in the x axis direction 449.

In the embodiment shown in FIG. 4C, the processor can also initiate an algorithm that can control the adjustment of nozzle ink ejection of the overlapping nozzles between printhead 458-1 and printhead 458-2 so as to reduce banding effects in printed images where the banding is a result of the ink ejection from a number of ink nozzles at the same location on the print media.

As discussed above, ink drops can land on media in a number of ways based upon misaligned printheads. In some cases, printheads can be in alignment but their nozzles can be affected in ways that cause ink drops not to fire at the same speeds or the same trajectories, as for example, where nozzles are partially clogged.

In various embodiments, a processor executing computer executable instructions can also be used to measure velocities of ink drop ejections and at least partially compensate for varying velocities of ink drops by adjusting the timing in which the ink drops are ejected.

For example, ink drops can be compared to each other to identify their velocity relative to each other. If the velocities of two different ink drops ejected from two different nozzles are measured, the differences in their velocities can be determined. Such embodiments can be accomplished as above, by monitoring when the drops pass through one or more of the planes of light.

In some embodiments, such as where the planes of light are not in the same physical plane, the velocity can be calculated if the distance between the two planes is known. Further, a processor can calculate the velocity of an ink drop by measuring the time between the ejection of the ink drop and when the ink drop passes through the planes of light in the x axis direction and/or the y axis direction if the distance to the plane detecting the passing of the ink drop is known. For example, in such embodiments, the velocity can be calculated by knowing the printhead to plane distance. The printhead to plane distance can be described as the distance 236 illustrated in FIG. 2B.

In some embodiments, the angle of ejection, e.g. trajectory of an ink drop can be measured. For example, an ink drop ejected from a particular nozzle can be detected by a sensor when passing through a plane of light and its position in one or more dimensions can be identified, as discussed herein. This position can then be compared to an alignment position stored in memory. Based upon the difference in position, the angle of ejection can be determined.

Since orientation of the planes of light can be established with respect to the trajectory of ink drops ejected from nozzles of the printheads, by knowing the intended trajectory (e.g., perpendicular to one of the planes of light), the angle of the trajectory can be computed. For example, by comparing the intended trajectory to a detected position of the ink drop passing through a plane of light, a processor can calculate a positional difference between the intended trajectory and the detected position of the ink drop. If a positional difference is calculated, the processor can execute computer executable instructions for adjusting the ejection of the ink drop, as for example, by inactivating the nozzle or by changing the timing of ejection of the ink. By measuring the angle of ejection, printheads ejecting ink at incorrect angles can be adjusted, as for example, by inactivating the nozzle to achieve a desired image quality.

Although specific embodiments have been illustrated and described herein, those of ordinary skill in the art will appreciate that any arrangement calculated to achieve the same techniques can be substituted for the specific embodiments shown. This disclosure is intended to cover any and all adaptations or variations of various embodiments of the present disclosure.

It is to be understood that the above description has been made in an illustrative fashion, and not a restrictive one. Combination of the above embodiments, and other embodiments not specifically described herein will be apparent to those of skill in the art upon reviewing the above description.

The scope of the various embodiments of the present disclosure includes any other applications in which the above structures and methods are used. Therefore, the scope of various embodiments of the present disclosure should be determined with reference to the appended claims, along with the full range of equivalents to which such claims are entitled.

In the foregoing Detailed Description, various features are grouped together in a single embodiment for the purpose of streamlining the present disclosure. However, embodiments of the present disclosure may or may not use more features than are expressly recited in each claim.

Rather, as the following claims reflect, inventive subject matter lies in less than all features of a single disclosed embodiment. Thus, the following claims are hereby incorporated into the Detailed Description, with each claim standing on its own as a separate embodiment.

What is claimed:

1. A detection apparatus for printhead adjustment, comprising:
a first light source for producing a first plane of light;
a second light source for producing a second plane of light; and
a sensor for detecting an ink drop passing through at least one of the first and second planes of light.

2. The apparatus of claim 1, wherein the apparatus includes a processor for determining an x axis dimensional position and a y axis dimensional position of the detected ink drop.

3. The apparatus of claim 2, wherein the processor can determine a velocity of the detected ink drop.

4. The apparatus of claim 2, wherein the processor can determine a trajectory of the detected ink drop.

5. The apparatus of claim 1, wherein the first and second planes of light are oriented within a same physical plane.

6. The apparatus of claim 1, wherein the apparatus includes a lens to form the first plane of light in an x axis direction.

7. The apparatus of claim 1, wherein the apparatus includes a lens to form the second plane of light in a y axis direction.

8. The apparatus of claim 1, wherein the first and second light sources each include:
a mirror to widen and reflect the formed first and second planes of light for detection by the sensor.

9. The apparatus of claim 1, wherein the sensor can detect a shadow produced by the ink drop passing through the at least one of the first and second planes.

10. The apparatus of claim 1, wherein at least one of the first and second planes of light is positioned between a printhead and a print media.

11. The apparatus of claim 1, wherein at least one of the first and second planes of light is positioned in a service station of a printing device positioned away from a print zone.

12. The apparatus of claim 1, wherein at least one of the first and second planes of light is positioned in a service station of a printing device positioned in a print zone.

13. The apparatus of claim 1, wherein at least one of the first and second planes of light is perpendicular to a trajectory of the ink drop.

14. An adjustment apparatus, comprising:
a light source for producing a plane of light;
a sensor positioned to detect a position of an ink drop ejected from a nozzle of a printhead; and
a processor to determine the position of the ink drop based on the detected position, wherein the detected position includes data received from the sensor that represents an x axis position and a y axis position of the ink drop on the plane of light.

15. The apparatus of claim 14, wherein the processor includes a configuration to interpret the data to identify a rotational offset of at least two different printheads.

16. The apparatus of claim 14, wherein the processor includes a configuration to interpret the data to identify a y axis offset between at least two ink drops ejected from two different printheads.

17. The apparatus of claim 14, wherein the processor includes a configuration to interpret the data to identify an x axis offset between at least two ink drops ejected from two different printheads.

18. The apparatus of claim 14, wherein the processor includes a configuration to interpret the data to identify a rotational offset of a printhead, the rotational offset determined from a detected position of two ink drops ejected from the same printhead relative to a reference line.

19. The apparatus of claim 14, wherein the processor is operable to adjust ink ejection timing of a number of nozzles based upon a y axis offset.

20. The apparatus of claim 14, wherein the processor is operable to adjust ink ejection timing of a number of nozzles based upon an x axis offset.

21. The apparatus of claim 14, wherein the processor is operable to adjust ink ejection timing of a number of nozzles based upon one of: a rotational offset of a printhead, and a rotational offset of at least two different printheads.

22. The apparatus of claim 14, wherein the apparatus has at least two printheads and wherein the two printheads have a nozzle overlap zone, and wherein the processor is operable to adjust ink ejection of a number of the nozzles based upon an x axis offset to reduce redundant ink drop ejection within the nozzle overlap zone.

23. The apparatus of claim 14, wherein the processor is operable to calculate a velocity of the ink drop based upon a difference in time between ejection of the ink drop and detection of the ink drop by the sensor.

24. The apparatus of claim 23, wherein the processor is operable to adjust the timing of ejection of the ink drop based upon the determined velocity.

25. A method, comprising:
determining a position of an ink drop within a plane of light based upon detecting the ink drop crossing the plane of light.

26. The method of claim 25, further including generating the plane of light.

27. The method of claim 25, further including ejecting the ink drop toward the plane of light.

28. The method of claim 25, wherein determining a position of an ink drop includes determining a position of an ink drop within a collimated plane of light.

29. The method of claim 25, wherein determining a position of an ink drop includes determining a position of an ink drop within a collimated plane of light oriented in an x-axis direction.

30. The method of claim 25, wherein determining a position of an ink drop includes determining a position of an ink drop within a collimated plane of light oriented in a y-axis direction.

31. The method of claim 25, further including generating a first plane of light directed in a first direction and wherein the method further includes generating a second plane of light directed in a second direction wherein the first direction is perpendicular to the second direction and wherein determining a position of an ink drop is based upon detecting the ink drop crossing at least one of the first and second planes of light.

32. The method of claim 25, further including detecting the ink drop with a sensor.

33. The method of claim 32, wherein detecting the ink drop with a sensor includes detecting the ink drop with a charged coupled device.

34. A method for ink ejection adjustment, comprising:
detecting a number of ink drops passing through a plane of light;
determining the position of each of the number of ink drops based upon the passing of each ink drop through the plane of light;
measuring a positional difference between the number of ink drops based upon the determined position; and
adjusting printhead ink ejection firing based upon the positional difference.

35. The method of claim 34, wherein measuring the positional difference includes a y axis offset between two printheads.

36. The method of claim 34, wherein measuring the positional difference includes an x axis offset between two printheads.

37. The method of claim 34, wherein measuring the positional difference includes a rotational offset between two printheads.

38. The method of claim 34, wherein measuring the positional difference includes a rotational offset of a printhead.

39. An image forming system, comprising:
at least two printheads for ejecting ink drops; and
an ink drop detection apparatus, including:
a light source for producing a collimated plane of light;
a sensor for detecting a position of the ink drops passing through the collimated plane of light; and
a processor to determine the position of the ink drops based on the detected position of the ink drops.

40. The system of claim 39, wherein the processor determines an x axis offset, a y axis offset, and a rotational offset of the at least two printheads based on the x axis and the y axis position of the ink drops ejected from the at least two printheads.

41. The system of claim 39, wherein the processor adjusts the timing of the ejection of the ink drops based upon the determined x axis offset, y axis offset, and rotational offset.

42. The system of claim 39, wherein the processor determines a rotational offset of a printhead, and adjusts the firing of ejection of the ink drops based upon the determined rotational offset of the printhead.

43. The system of claim 39, wherein the ink drop detection apparatus moves to a position below the printheads in a print zone.

44. An apparatus for printing, comprising:
a light source and a sensor to provide data about positioning of a number of nozzles of at least two printheads; and
means for determining a positional offset of the at least two printheads based on the data.

45. The apparatus of claim 44, wherein the means for determining the positional offset includes at least one of a y axis offset, an x axis offset, and a rotational offset.

46. The apparatus of claim 44, including means for adjusting a timing of ejection of ink drops ejected from the number of nozzles based upon the positional offset.

47. A computer readable medium having a set of executable instructions for causing a device to perform a method, comprising:
detecting a number of ink drops passing through a plane of light;
determining the position of each of the number of ink drops based upon the passing of each ink drop through the plane of light;
measuring a positional difference between the number of ink drops based upon the determined position; and
adjusting printhead ink ejection firing based upon the positional difference.

48. The computer readable medium of claim 47, wherein determining the position of each of the number of ink drops includes determining x and y dimensions for each of the number of ink drops.

49. The computer readable medium of claim 48, wherein the x and y dimensions for each of the number of ink drops are compared to reference x and y dimensions stored in a memory.

50. The computer readable medium of claim 47, wherein adjusting printhead ink ejection timing further includes adjusting based on the comparing the reference x and y dimensions stored in memory to the measured positional difference between each of the number of ink drops.

51. A computer readable medium having a set of executable instructions for causing a device to perform a method, comprising:
determining a position of an ink drop within a plane of light based upon detecting the ink drop crossing the plane of light.

52. The computer readable medium of claim 51, the method further including generating the plane of light.

53. The computer readable medium of claim 51, the method further including ejecting the ink drop toward the plane of light.

54. The computer readable medium of claim 51, wherein determining a position of an ink drop includes determining a position of an ink drop within a collimated plane of light.

55. The computer readable medium of claim 51, wherein determining a position of an ink drop includes determining a position of an ink drop within a collimated plane of light oriented in an x-axis direction.

56. The computer readable medium of claim 51, wherein determining a position of an ink drop includes determining a position of an ink drop within a collimated plane of light oriented in a y-axis direction.

57. The computer readable medium of claim 51, the method further including generating a first plane of light directed in a first direction and wherein the method further includes generating a second plane of light directed in a second direction wherein the first direction is perpendicular to the second direction and wherein determining a position of an ink drop is based upon detecting the ink drop crossing at least one of the first and second planes of light.

58. The computer readable medium of claim 51, further including detecting the ink drop with a sensor.

59. The computer readable medium of claim 58, wherein detecting the ink drop with a sensor includes detecting the ink drop with a charged coupled device.
